(19) United States
(12) Patent Application Publication
(10) Pub. No.: US 2017/0341311 A1
(43) Pub. Date: Nov. 30, 2017

(54) PLANT FOR MANUFACTURING BAGS FROM TWO LAYERS OF PLASTIC FILM, METHOD FOR OPERATING SUCH A PLANT AND BAG

(71) Applicant: KIEFEL GmbH, Freilassing (DE)

(72) Inventor: Thomas WILHELM, Traunstein (DE)

(73) Assignee: KIEFEL GmbH, Freilassing (DE)

(21) Appl. No.: 15/513,480

(22) PCT Filed: Jul. 17, 2015
(86) PCT No.: PCT/DE2015/000358

§ 371 Date: Jul. 25, 2017

(30) Foreign Application Priority Data
Sep. 22, 2014 (DE) 10 2014 013 729.5

(51) Int. Cl. B29C 65/00; B31B 70/85; B65G 15/30; A61J 1/10; B29L 31/00; B31B 70/00

(52) U.S. Cl. CPC B29C 66/71; B65G 15/30; A61J 1/10; B31B 70/85; B31B 70/00; B29L 2031/7148

(57) ABSTRACT

An installation for producing bags from two-layer plastic film includes a film gripper for drawing the plastic film into a tool at a first station, and a rotary conveyor belt for conveying the film through a plurality of stations. The film gripper is designed to guide the plastic film through the first station to a second station.

### TECHNICAL FIELD

The disclosure refers to a plant for manufacturing bags from two layers of plastic film, a method for operating such a plant and to a bag.

### BACKGROUND

The manufacturing of bags from plastic film is a common procedure. It is particularly relevant in the production of medical bags such as bags prefilled with liquid for infusions.

EP 1 780 000 A1 describes a method in which a gripper draws the film into a combined welding and cutting tool. The tool closes, the grippers are released and move back in order to grip the next film advancing.

In the production of medical bags, connection pieces are inserted between the films, normally small plastic tubes of, for instance, cylindrical cross-section.

The disclosure is based on the task of providing an improvement or an alternative to the state of the art.

### SUMMARY

In a first aspect of the disclosure, the task is solved by providing a plant for manufacturing bags from two layers of plastic film, the plant having a film gripper for drawing the plastic film into a tool at a first station, as well as a circulatory transport belt for transporting the film through several stations, the plant being characterized by the fact that the film gripper is adapted to guide the plastic film beyond the first station to a second station.

The terminology will be explained in the following:

“Manufacturing” is preferably not only a production of the bags by means of a joining tool, such as a welding tool, but preferably also a filling of the bag with a liquid and/or provision of the bag with an access point such as a tube or a different type of port.

The “two” layers of plastic film are intended to be “at least two” layers.

As a rule, indefinite articles like “one”, “two” etc. are to be understood within the framework of the present application as indicating a minimum, that is, “at least one . . . ”, “at least two . . . ” etc., unless it is clear from the context that “exactly one . . . ”, “exactly two . . . ” etc. are intended.

A “film gripper” can be any means which can exert a force on the film in the machine direction, where the film can be selectively destroyed at certain places or touched in a non-destructive manner. In particular, both means are considered which touch the film either on one side or on both sides, that is, e. g. perforate or clamp it.

Drawing of the plastic film “into” a tool is to be understood in the sense that the film advances either as an endless film layer or in the form of pre-cut pieces of film, namely moving not yet in the circulating path of the later finished use parts, that is, along the transport belt, but still in the feed to the transport belt. The decisive point here is that advancing film is to be gripped in order to finally move with the transport belt in whatsoever form.

The first “station” is intended to be, in particular, a tool station, that is, a station which exerts a mechanical force on the structure of the film. In an extended view, non-mechanical stations can be intended as well, for instance, a preheating station with radiant heaters. In a preferred embodiment of the disclosure, however, the first station is a tool station which connects the two layers of the plastic film by means of a joining tool, in particular a welding tool, which can also be a combined welding and cutting tool or a different type of combined joining and cutting tool.

“Several stations” indicates at least a subgroup of those stations in which, in the circulation direction of the transport belt, stations are arranged. For instance, a station for adhering a tube to the film, a station for circumferentially welding the tube to the film, a station for circumferentially welding the bag, a station for orienting the bag by swiveling, a station for filling the bag, a station for cutting a use part or several individual bags, a station for printing or a station for otherwise labeling the bags and/or for transferring the bags can be provided in the plant along the circulating transport belt.

According to the disclosure, the film gripper is adapted to guide the plastic film beyond the first station to a second station. Continuity of guidance has advantageous effects on the precision of guidance and therefore on the quality of the manufactured products.

Whereas in the state of the art, the gripper releases the film and moves back, and therefore transfers the film with an imprecision which can naturally never be avoided, here the guidance remains identical. That is, when the film gripper grips the film with high precision in order to draw it into the first station, the same precision is maintained in output from the first station, and in input to the second station and, if possible, also at several or even at all other stations.

In addition, the plant can preferably be adapted to grip the leading edge of the film at the very front. In this case, a sagging of the leading film edge, which is possible in the state of the art, is not only avoided when the film is drawn into the first station, but also in the further transport path of the film which leads through the at least one additional, preferably all, stations of the plant.

An extremely high precision of transport can be achieved if the film gripper is arranged at the transport belt.

The transport belt of a plant of the generic kind is guided with very high precision, anyway. This normally applies not only to positioning along the circulating path of the transport belt, but also to a position which is perpendicular thereto. In case of a horizontally moving transport belt, this means that a high guiding precision is ensured also in the vertical direction and with reference to any deviations towards the outside or the inside which might otherwise occur. In addition, a drive arranged at any desired position alongside a circulating transport belt can easily be used to precisely control or regulate each of its mountings, guides and grippers of the entire transport belt.

In order to exploit, on the one hand, the precision of the transport belt and, on the other hand, create a degree of freedom with which the arriving film can be gripped at the transport belt, it is proposed for the film gripper to be arranged slidably alongside the transport belt.

A slidable arrangement can be achieved in very different ways. For instance, a friction bearing or a guiding system based on rollers, needles or other roll bodies can be provided by means of which the film gripper can be shifted alongside the transport belt in the longitudinal direction.

It is particularly preferred for the film gripper to be slidable only over a portion between two sliding limits in the longitudinal direction, wherein the sliding limits being preferably secured locally to the transport belt.

If a feed actuator independent of the transport belt is provided for the film gripper, then the feed actuator can be attached, for instance, to the machine frame, independently of the machine frame or to a feed actuator for the arriving film. Alternatively, it is even conceivable that the feed actuator independent of the transport belt is in fact attached to the transport belt but that it also has a drive relative to the transport belt.

In any case, the feed actuator independent of the transport belt can be used to move the film gripper independently of the transport belt, in fact preferably along the transport belt circulating path, at a higher speed than that of the transport belt itself.

If the feed actuator independent of the transport belt performs a stroke movement, in particular a linear stroke movement, then it is proposed in terms of construction that the feed actuator independent of the transport belt moves the film gripper by maximally the distance of its own stroke with respect to the film transport belt, no matter if the transport belt is standing still during activation of the film gripper by the independent feed actuator or whether it moves in the circulating direction during the machine cycle.

Preferably, the feed actuator independent of the transport belt is arranged such as to engage, with a linear movement, the designated circulating path of the film gripper on the transport belt, in fact preferably directly downstream of a reversing mechanism of the transport belt, wherein a piston, a lifting rod or a different means which actuates the film gripper and is actuated by the feed actuator being able to actuate and advance the film gripper bypassing the other mountings, carriers or supports. This process can be time-controlled, wherein the feed actuator is moving into the movement space of a subsequent support or the like and moving out in time before a collision; or it can be spatial-arranged, with the film gripper having provided a point of application where the feed actuator can be applied without colliding with the other supports or similar at the transport belt.

A feed actuator can be arranged either inside the space of the circulating transport belt or outside the same. If it is arranged inside, the plant regularly occupies less space in the production shed. On the other hand, especially movable parts can be better accessed and therefore better maintained from the outside of the plant.

It is pointed out that the feed actuators mentioned in the present patent application not necessarily have to push the film gripper, but that they can also pull it.

The feed actuator independent of the transport belt is preferably adapted to provide a feed movement along the transport belt. Especially in the case of a film gripper which is supported slidably alongside the transport belt, a strong synergistic effect can be observed: the feed actuator independent of the transport belt can displace the film gripper along the transport belt in the transport belt circulating direction with respect to the transport belt, in fact preferably with an acceleration, i. e. with a feed movement in relation to the transport belt.

A preferred embodiment of the disclosure provides for a second feed actuator for the film gripper which is independent of the transport belt.

Such a construction is particularly advantageous if the first feed actuator independent of the transport belt is adapted to move the film gripper forward in relation to the transport belt or to transfer it to the second independent feed actuator for the film gripper at the end of its stroke.

The first and/or the second feed actuator independent of the transport belt is/are preferably supported in a fixed position by a machine frame and are preferably embodied such that they can be moved into a circulating path of the film gripper along the transport path.

For improving the precision during transfer of a film gripper, it is suggested that the first or the second feed actuator independent of the transport belt have a centering means for precisely positioning the film gripper.

A centering means can have a concave surface, for instance with the body of a hollow sphere or hollow cone, particularly on one side, for instance on the film gripper, whereas on a different side, for instance on the feed actuator, a smaller element is provided which can be inserted in the concave shape and is centered there due to the shape of the slanted lateral walls.

To achieve a good absolute or relative synchronization of movement with the arriving film, it is proposed that the first or second feed actuator independent of the transport belt be coupled or synchronized with a film feed actuator, that is, a feed actuator for the arriving film, in particular with a feed bar also called clamping bar.

In a simple but nevertheless extremely precise construction, at least one of the two feed actuators independent of the transport belt is attached to the film feed actuator.

It is proposed that the first and/or the second feed actuator independent of the transport belt be reversible whereas preferably the film gripper is provided to be driven only in the circulating direction. Such an embodiment particularly allows the first and/or the second feed actuator to provide, with machine timing, the film gripper with a feed movement, to then retract intermittently and thus be available to the next film gripper. In contrast, the film gripper which last received a feed movement continues to circulate with the transport belt. Such a construction especially makes sense if a plurality is provided in the plant, especially at the transport belt.

The film gripper can have, for instance, a needle for needling the plastic film.

In the state of the art, needle chains are known. The advantage of a needle is that it can pierce the film within a very short time. In addition, it can keep its position very securely, for as long as no tear is produced in the film from the needling hole, the film continues to be guided precisely with the needle.

In the plant structure proposed here, which aims at a very high precision, anyway, needling is a very suitable means with which the film gripper can grip the film.

For needling, it is proposed that a counter-block be arranged opposite to the needle which has a recess aligned with the needle.

If a plurality of needles are provided at a gripper, a counterforce can be built up at a respective counter-block for only one, for more than one or for all of the needles, where the recess can be positioned only for one needle or, alternatively, for more than one or for all needles.

For the film gripper to be able to grip the film, it is proposed that the film gripper have a stroke actuator adapted to lift a film engagement means, particularly a needle, with respect to a film level.

Such a stroke actuator can be, for instance, a driven carriage. An elegant technical construction provides for the film gripper to have a body guided on the transport belt and a carriage supported by it and slidable in relation to it, wherein the gripping means for the film, for instance the needle or the clamp, being basically arranged on the carriage. Such a carriage can be moved by an actuator entrained by the film gripper; as an alternative, the actuator can be separated from the film gripper and arranged, for instance, on the machine frame or at a station or on the transport belt.

In case of a horizontally circulating transport belt, it is proposed for the stroke actuator to move the film gripping means vertically upwards or downwards, but preferably upwards. In an upward stroke, gravity acting on the film helps with needling or in some other manner gripping the film.

Alternatively or in addition to a needle, an aspiration device can be provided at the film gripper for aspirating the plastic film. An aspiration device can be, for instance, a hose with a preferably soft opening region for contacting the film, which hose is connected to a vacuum means at the back so that ambient air is aspirated through the hose towards the vacuum means until the aspiration device contacts the film. The film is then closely aspirated towards the hose and kept there in a nondestructive manner with a suitable construction and vacuum setting.

Alternatively or in addition, it is proposed for the film gripper to have a clamping jaw for clamping the plastic film from a top and a bottom. Also when it is clamped in, the film can be guided in a non-destructive manner.

Another alternative or additional possibility for retaining the film provides for a magnet clamping body. Such a magnet clamping body preferably has a fixed magnet and a counter magnet which can be activated electrically so that the clamping force can be switched on and off electrically. Two permanent magnets are conceivable as well; when they are moved together, there comes a point when they snap together and exert a clamping force on the film. For opening, one permanent magnet only needs to be removed from the other to a sufficient extent until for example a retaining force, which can also be caused by a slippage resistance, prevents renewed unintentional snapping and keeping the gripper open for gripping a new piece of film.

Independently of the exact manner in which the film gripper retains the film, it is proposed that the transport belt and the film gripper be adapted such that the film gripper is slid from the first to the second station by a central electrode block, preferably with a spacer, in the circulating direction of the transport belt.

Hereto it needs to be notionally clarified that a “central electrode” is to be understood as a “Mandrene” in German technical terminology. A central electrode is advantageously used especially when medical bags are produced. For with these bags, normally an inlet having the form of a small tube with a round cross-section or otherwise is welded in between the films so as to create an access from the outside to the inside. For securely welding in the tube or other type of inlet between the film layers, normally a central electrode is slid into the tube. Between the central electrode and the counter-electrodes acting on the outside of the film layers, the welding field then builds up.

With a suitable design of the plant, the central electrodes can now be ideally used to further transport the bags which have now been at least partially welded. A synergistic effect results from the fact that the central electrode blocks, which substantially comprise a support body and one or more central electrodes, are arranged at the transport belt, anyway, and are normally also secured there. Therefore, a drive means exerting force on the transport belt, especially a motor with or without a gear, directly has a corresponding movement effect on the central electrode blocks. In other words, the central electrode blocks automatically move together with the transport belt in precisely predefined and constant positions.

A film gripper arranged at the transport belt, especially in a slidable manner in the longitudinal direction, is therefore simply entrained by the central electrode block located upstream with respect to the circulating direction.

For preventing the film gripper from abutting directly against the central electrode block if this is not desired, a spacer can be provided.

In any case, a forward transport of the central electrode blocks results in an automatic joint forward transport of the film gripper.

Thus, the film grippers do not need their own individual drives, which makes the plant not only less expensive to build, but also very easy to maintain.

With regard to an entire plant, it is proposed to provide several film grippers between which central electrodes of a use part are located.

In particular, it should be bore in mind that a use part can have the area between two successive film grippers, wherein its length corresponds to a feed distance of the machine cycle. A use part can have one or more central electrodes and one or more central electrode blocks, just like each central electrode block can have one or more central electrodes, where the number of central electrodes per central electrode block can vary or can be homogeneous.

Along a circulating direction, a plurality of stations can be arranged. One example for the stations of a plant of the generic kind can be found in EP 2 585 376 A1.

Above all, it is intended that a feed actuator for a film gripper be adapted to drive the film gripper with the gripped film into a welding station whereas in the circulating direction downstream of the welding station, the film is transported with the transport belt. It is explicitly pointed out that the welding station can also be a combined welding and cutting station.

In a second aspect of the present disclosure, the task is solved by providing a plant for manufacturing bags from two layers of plastic film, having a film gripper for drawing the plastic film into a tool at a first station and a circulating transport belt for transporting the film through several stations, wherein the plant being characterized in that it is adapted to couple the film gripper with a transport belt feed actuator over a first distance and with a feed actuator independent therefrom over a second distance.

The “first distance” can have a different length than the “second distance”. It is preferable for the first distance to be substantially longer than the second distance, in particular to be longer many times over.

The second distance can preferably correspond to the feed length of a machine cycle.

The “independent feed actuator” mentioned here corresponds to the first or to the second feed actuator independent of the transport belt, which is mentioned in the above description.

Preferably, the plant is adapted to couple the film gripper, over a third distance, with a second feed actuator independent of the transport belt feed actuator.

When a second and a third distance are advanced by means of feed actuators independent of the transport belt, it is then an advantage if at least one, preferably exactly one, of these two distances corresponds to the feed distance of a machine cycle.

In particular, a construction is disclosed where a film gripper is transported together with the central electrode blocks at the transport belt in the circulating direction and in fact directly before the central electrode blocks, to be more precise, at the beginning of each use part, a film gripper is provided and so circulates. After a change in direction, in the area of feeding the film to the transport belt, a first independent feed actuator moves the film gripper relatively faster than the transport belt circulates, i. e. towards the central electrode block, located in the back, of the previous use part, without however completely arriving there. The first feed actuator stops the film gripper there. The film gripper can then grip the film, for instance, needle the film. The second feed actuator independent of the transport belt then guides the film, together with the film feeding, into a first tool, particularly a welding tool. When the feed actuator is arranged at the film feed actuator, it is basically an element of the film feed actuator which grips the film edge at the front. The distance covered by it in the course of this stroke will then be precisely the feed distance of the advancing film, that is, the stroke of a machine cycle. From there on, the second feed actuator can then again leave the film gripper to the entrainment by the transport belt.

It is explicitly pointed out that the introduced aspects of the disclosure can be used alternatively or in combination. That is, it is conceivable to provide a plant implementing the features of the first aspect of the disclosure, but not of the second aspect; on the other hand, it is just as well conceivable that a plant implements the second aspect of the disclosure, but not the first aspect.

However, particularly preferred embodiments of the disclosure implement both aspects.

Additionally, it is explicitly pointed out that all optional sub-features which have been described for at least one of the two aspects can also be advantageously combined with the other aspect of the disclosure.

In a third aspect of the disclosure, which also can be combined alternatively and cumulatively with the aspects introduced above, the task is solved by a method for operating a plant for manufacturing bags from two layers of plastic film, having a film gripper for drawing the plastic film into a tool at a first station as well as a circulating transport belt for transporting the film through several stations, the method being preferably characterized by the following steps:

Positioning of the film gripper for gripping the plastic film in fact by means of a relative movement of the film gripper with respect to the transport belt and/or with respect to a film feed actuator; gripping of the plastic film; drawing the plastic film into the tool at the first station by means of the film gripper, in fact coupled or synchronized with the film feed actuator; and drawing the plastic film further to the second station by means of the film gripper, in fact coupled or synchronized with the transport belt.

Positioning of the film gripper for gripping the plastic film can take place by sliding the film gripper forward along the transport belt by means of a first feed actuator which preferably moves back afterwards.

By sliding the film gripper forward, the gripper is given time to grip the film before it is again moved on by its carrier at the transport belt.

Gripping of the film can preferably take place by needling the plastic film on the film gripper.

The film is drawn into the first station preferably by means of a second feed actuator which is preferably directly connected mechanically to a film feed actuator, in particular to a film feed beam.

For the film feed, clamping bars are frequently used in the state of the art. Such a bar extends transversely to the machine direction above and below the film sheet to be fed in. When the bars move together, they clamp the film between them and can move it forward by a feed in the machine direction. After this, the bars move apart again and drive back. Coupling of the second feed actuator directly with the film feed actuator allows particularly high precision in synchronization with the feed of the film to be advanced. In addition, the second feed actuator in this case does not need a separate relative drive with respect to the film feed actuator, which again saves maintenance efforts and makes the plant more precise.

After the plastic film has been drawn into the first tool, the second feed actuator can preferably disengage the plastic film and move back.

In case of a mechanical coupling with the film feed actuator, a moving back takes place anyway since the film feed actuator intermittently moves back in order to grip the new film to be advanced.

After the second feed actuator has disengaged the film gripper, it is proposed that the film be further transported by a transport belt feed actuator, for instance a motor with or without a gear causing the circulating movement of the transport belt.

It has already been proposed that a central electrode block can shove the film gripper with its front face.

When the plant is adapted and/or the method is performed such that the film gripper grips the plastic film at the level of a product to be manufactured, this may entail various advantages.

Gripping at “the level” of a product to be manufactured takes place when the point of engagement of the film gripper in a projection vertical to the machine direction overlaps with a projection of the manufactured product which is also vertical to the machine direction.

In other words, the engagement point of the film gripper, for instance the needling points, lies at the level of the bags in the longitudinal extension of the film sheet, no matter whether it has already been cut or is in the form of connected use parts. A medical bag normally has a broader part for receiving liquid and a tapering part which finally accommodates the port. The transport direction is vertical to the arrangement of the bags. That is, the ports are located laterally to the film sheet, and the bag is moved through the plant laterally in the machine direction.

Between the tapering neck and the shoulder of the flaring part of the bag, there is a surface in which needling or some other form of retaining can take place without the liquid receiving structure of the bag being damaged. In particular, if the bag gripper contacts the film in this area, it is even possible to produce bags free of waste; for the bags can be cut transversely to the machine direction while the gripper touches the film in this area.

Scrap-free cutting or punching can take place between successive use parts as well as between the individual products, mostly bags, of each individual use part.

It is understood that the advantages of the manufacturing method, due to increased manufacturing precision, also extend to a bag, particularly to a medical bag filled with a liquid with one or more ports which has been produced with a device and/or a method as described above.

### BRIEF DESCRIPTION OF THE DRAWINGS

In the following, the disclosure will be explained in more detail using an example of embodiment with reference to the drawings wherein:

FIG. 1 schematically shows a spatial view of part of a plant for manufacturing medical bags, having a circulating transport belt, a first feed actuator, a second feed actuator, a vertical stroke actuator and a feed beam, in an engagement position of the first feed actuator, that is, at an end of a first feed,

FIG. 2 shows, in a view as in FIG. 1, a chronological subsequent situation in which the vertical stroke actuator is active,

FIG. 3 shows, in a view analogous to FIGS. 1 and 2, a chronological subsequent situation in which the vertical stroke actuator is withdrawn,

FIG. 4 shows, in a view analogous to FIGS. 1 through 3, on a slightly larger scale, a chronological subsequent situation in which the second feed actuator has been active, and

FIG. 5 schematically shows a detail of the situation in FIG. 3 from a slightly lower perspective view.

### DETAILED DESCRIPTION OF THE DRAWINGS

Plant 1 in the Figures substantially comprises different workstations (not shown) which share in the tasks for manufacturing a medical bag. For instance, there is a roller feed in which two rollers of plastic film are provided. Such a station normally represents the beginning of the film's path through the plant in the machine direction.

To keep the tensile stress during introduction in the first machining tools as constant as possible, a dancer roll arrangement can be provided.

A preheating station can be provided.

The first workstation in a plant of the kind described here by way of example is normally a welding tool, even if the welding tool as such is not shown.

The welding tool can be, for instance, a combined welding and cutting tool, or welding or even pre-welding can be performed by itself. For instance, plants are known wherein the tubes which will form ports in the medical bag later on are first only temporarily adhered thermally to the film.

In most cases, this will be followed by post-welding stations, transfer stations, filling stations and/or labeling or printing stations for the medical bags.

The first workstation 2 (the position of which is indicated but which is not shown) is located, just like the other workstations, alongside the circulating transport belt 3. The circulating transport belt 3 is driven by a motor (not shown) in the machine direction 4, 5, 6.

On the transport belt 3, a plurality of central electrode blocks 7 (numbered by way of example) are secured by fixed securing means such as screws 8 (numbered by way of example).

Two central electrode blocks 7 each form one central electrode block pair 9 (numbered by way of example) of a use part in the manufacturing of medical bags. In a machine cycle corresponding to the length of a use part, two central electrode holders will therefore hold one use part and four central electrodes will be able to weld in small tubes between the two film layers in manufacturing of the bags.

Holding of the bags by means of central electrode blocks is already known from the state of the art, for instance from EP 2 026 951, and will therefore not be described here in detail.

In a space 10 (numbered by way of example) between two adjacent central electrode block pairs 9 of a use part, a needle gripper block 11 (numbered by way of example) is located. The needle gripper block 11 substantially comprises a gliding body 12 which is arranged slidably in the longitudinal direction on the transport belt 3 and a needle gripper 13 arranged on a vertical carriage 14 at the gliding body 12.

On a front side 15 of the transport belt 3, at the inlet of the straight path, there is a first feed actuator 17 located after a direction change mechanism 16. The first feed actuator 17 substantially comprises a stationary cylinder 18 and a first feed piston 19 which can be moved out of the cylinder 18 in a linear direction. The first feed actuator 17 is arranged in a horizontal moving direction such that the circulating central electrode blocks 9 can freely pass by the first feed actuator 17 if the first feed piston 19 is retracted, whereas the first feed piston 19 can in any case extend into the track of the gliding bodies 12 of the needle gripper blocks 11.

The extension speed of the first feed piston 19 is higher than the feed velocity of the transport belt 9 during the intermittent feed.

Also, a feed and a retraction of the first feed piston 19 can take place in less time than is needed for the pause in the cycle between two feeds of the plant.

At a first ejection end 20 of the first feed piston 19, that is, at the downstream end of a first feed distance 21, there is a second feed actuator 22 which can be moved in the linear direction, for instance, along a rail 23, via a second feed distance 24 along the machine direction 4 on the front side 15 of the transport belt.

For this purpose, the second feed actuator 22 substantially comprises a driving body 25 attached to the rail 23 and an extendable centering pin 26 which is attached to the driving body 25 so that it can be vertically driven upward and downward.

At a beginning of the second feed distance 24, there is also a vertical stroke actuator which is secured to the plant so as to be stationary. The vertical stroke actuator 27 substantially comprises a drive unit 28 and a vertical pusher 29.

The vertical pusher 29 is arranged such that in case of a vertical upward stroke, it definitely hits the vertical carriage of the needle gripper block 11 currently located at the ejection end 20 of the first feed distance 21, precisely the protruding driver 30 of the vertical carriage.

The plant operates as follows:

The transport belt 3 is intermittently moved through the plant in the machine direction 4, 5, 6.

Consequently, the central electrode blocks 7 are moved through the plant 1 in the machine direction 4, 5, 6 with the same clock pulse.

The foremost central electrode block 7 of each central electrode block pair 9 or of any larger or smaller number of central electrode blocks within a use part shoves with its front face the needle gripper block 11, which can slide freely along the transport belt 3, along its gliding body 12 in the machine direction 4, 5, 6.

That is, an arbitrarily chosen specific central electrode block 31 shoves an arbitrarily chosen needle gripper block 32 with its front face 33, along a back side 34 of the circulating transport belt 3 and around the direction change mechanism 16.

At the output of the direction change mechanism 16, consequently the exemplary needle gripper block 32 crosses the path of the first feed distance 21 of the first feed piston 19 of the first feed actuator 17. As soon as this happens, the first feed actuator 17 deploys the first feed piston 19. Then, with its front face, which can be buffered, for instance, with an elastomer, or which can assume a secure gripping position at the exemplary needle gripper block 32 by means of a magnet or similar, it pushes the exemplary needle gripper block 32 to a precisely predefined position at the output end 20 of the first feed distance 21. This position is set so as to be suited for needling of the film sheet or double-layer film sheet arriving from a direction 35.

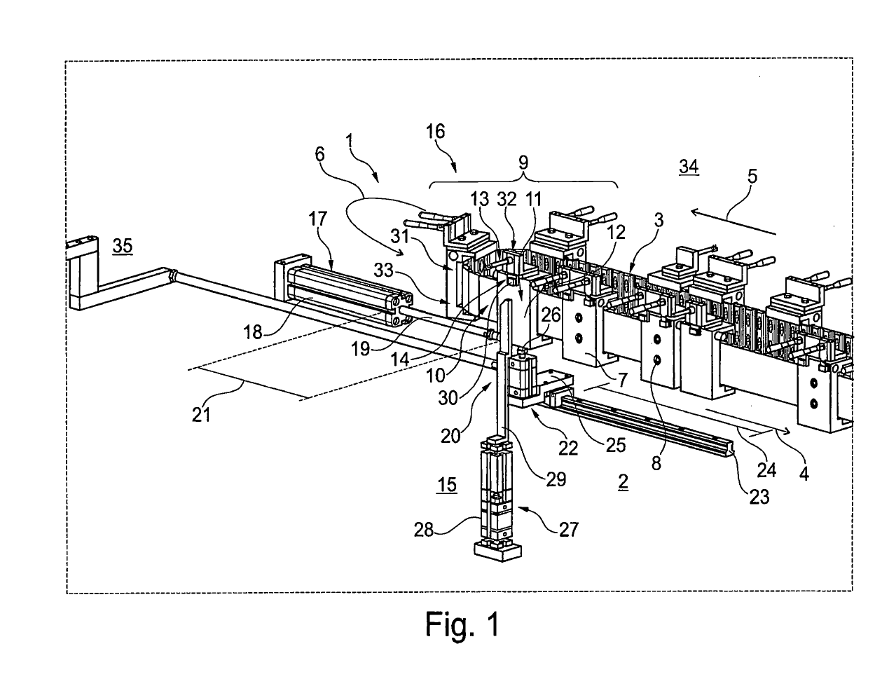

FIG. 1 shows the exemplary needle gripper block 32, which has already been advanced, at the output end 20 of the first feed actuator 17, that is, in precisely the correct position for needling of the film.

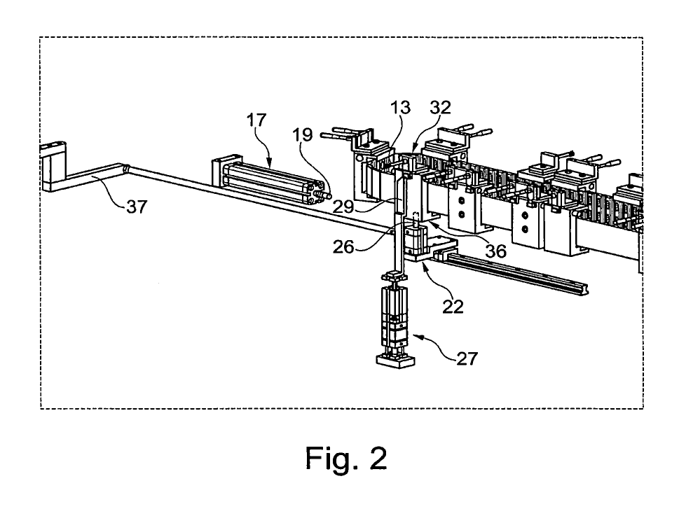

There, the vertical stroke actuator 27 and the second feed actuator 22 become active (see FIG. 2):

The second feed actuator 22 drives its centering pin 26 vertically upwards, and thus engages a centering element, for instance a spherical concave surface, at a bottom side 36 of the exemplary needle gripper block 32. Independently of the precision of the feeding movement of the exemplary needle gripper block 32, caused by the first feed actuator 17, the position of the needle gripper 13 on the exemplary needle gripper block 32 is predictable with maximum precision after centering on the centering pin 26.

The first feed actuator 17 which has brought the exemplary needle gripper block 32 in the centering position for the second feed actuator 22 has thus performed its task and retracts the first feed piston 19 so that it is available for the next cycle.

By way of a vertical upward deployment of the vertical pusher 29, the needle gripper 13 of the exemplary needle gripper block 32 is moved upwards with its gliding body 12. The position along the machine direction 4, 5, 6 remains unaltered and therefore set very precisely. The needles of the needle gripper 13 now engage the film sheet (not shown).

The driving body 25 of the second feed actuator 22 is fixed securely to a film feed beam 37 or to the frame thereof.

In the situation shown in FIG. 2, the needle gripper 13 thus engages the film. At the same time, the exemplary needle gripper block 32 is set for film feed.

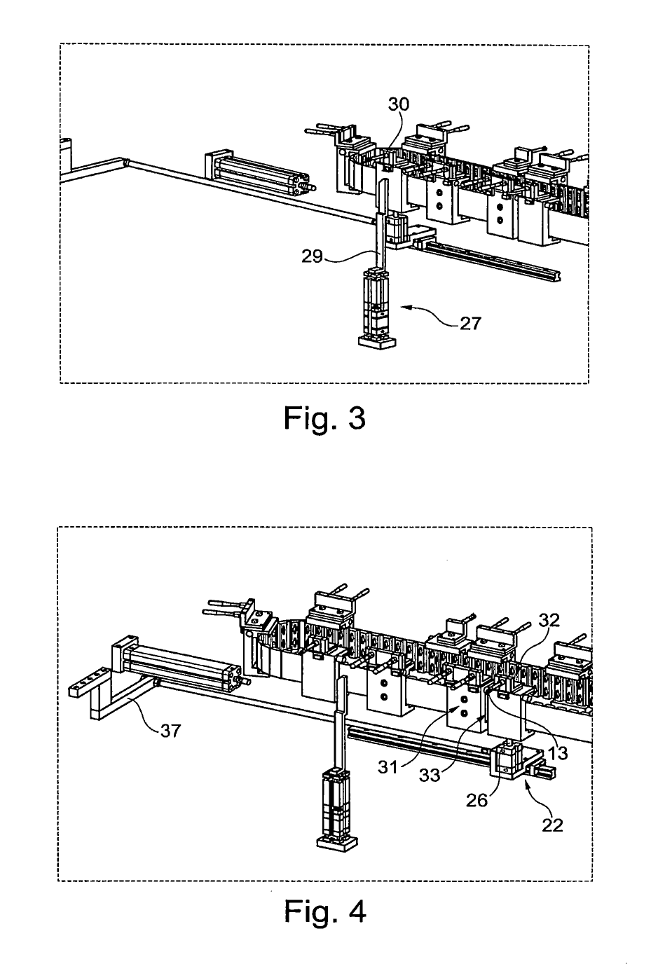

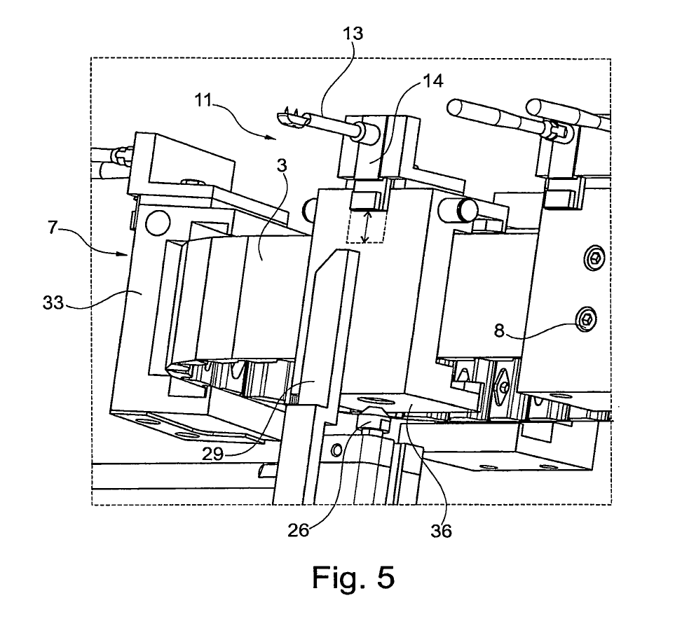

The vertical stroke actuator 27 then again pulls the vertical pusher 29 vertically downward and releases itself from the driver 30 of the exemplary needle gripper block 32 (see FIG. 3).

In the subsequent step (see FIG. 4), the film feed then drives a cycle together with the belt feed of the transport belt 3. During this cycle, the second feed actuator 22, driven by or in any case mechanically coupled to the film feed beam 37, draws the respective film by means of the needle gripper 13 into the first processing station, for instance the tool of a welding station, in particular a combined welding and cutting tool for welding at least part of the contour and/or of the ports of a medical bag, or in the present case, of two medical bags within a use part with two ports each.

The position of the needle gripper 13 is precisely known. Therefore, the centering pin 26 can again be moved vertically downward out of the centering means of the exemplary needle gripper block 32. At the same time, the foremost exemplary central electrode block 31 of the next use part has moved up and now abuts at the exemplary needle gripper block 32 with its end face 33 directly or by means of a spacer.

Starting from this situation, the film can be moved easily by means of the feed of the transport belt 3.

With this procedure, the needle gripper 13 of each needle gripper block 11 remains engaged even downstream of the first processing station (shown in FIG. 4), which allows maximum precision in guiding the film through the various stations.

After the centering pin 26 has retracted, the film feed beam 37 can drive back and is again available for feeding in the next advancing film.

1. A plant for manufacturing bags from two layers of plastic film, with a film gripper for drawing the plastic film into a tool at a first station and with a circulating transport belt for transporting the film through several stations, wherein the film gripper is adapted to guide the plastic film beyond of the first station to a second station.

2. The plant according to claim 1, wherein the film gripper is arranged at the transport belt.

3. The plant according to claim 1, wherein the film gripper is arranged slidably along the transport belt.

4. The plant according to claim 1, wherein a feed actuator for the film gripper, independent of the transport belt, is provided.

5. The plant according to claim 1, wherein a second feed actuator for the film gripper, independent of the transport belt, is provided.

6. The plant according to claim 4, wherein the first or the second feed actuator independent of the transport belt is locally secured to a machine frame and is configured to be extended into a circulating path of the film gripper.

7. The plant according to claim 4, wherein the first or second feed actuator independent of the transport belt has a centering means for precisely positioning the film gripper.

8. The plant according to claim 4, wherein the first or second feed actuator independent of the transport belt is coupled or synchronized with a film feed actuator.

9. The plant according to claim 4, wherein the first or the second feed actuator independent of the transport belt is retractable, whereas the film gripper is adapted to move only in the circulatory direction.

10. The plant according to claim 1, wherein the film gripper has a needle for needling the plastic film.

11. The plant according to claim 10, wherein opposite to the needle, a counterblock with a recess flush with the needle is provided.

12. The plant according to claim 1, wherein the film gripper has a stroke actuator adapted to lift a film engagement means with respect to a film level.

13. The plant according to claim 1, wherein the film gripper has an aspiration device for aspirating the plastic film.

14. The plant according to claim 1, wherein the film gripper has a clamping jaw for clamping the plastic film from a top side and from a bottom side.

15. The plant according to claim 1, wherein the transport belt and the film gripper are adapted such that the film gripper is slid by a central electrode block in the circulatory direction from the first to the second station.

16. The plant according to claim 1, wherein a central electrode is arranged at the transport belt.

17. The plant according to claim 1, wherein the central electrode is locally secured to the transport belt.

18. The plant according to claim 1, wherein several film grippers are provided, wherein between them, central electrodes of a use part are provided.

19. The plant according to claim 1, wherein several central electrodes are arranged at a central electrode block.

20. The plant according to claim 1, wherein two film grippers are spaced by the dimension of a feed cycle.

21. The plant according to claim 1, wherein a plurality of stations are arranged along a circulating direction.

22. The plant for manufacturing bags from two layers of plastic film, with a film gripper for drawing the plastic film into a tool at a first station and with a circulating transport belt for transporting the film through several stations, wherein the plant is adapted to couple the film gripper over a first distance with a transport belt feed actuator and over a second distance with a feed actuator independent thereof.

23. The plant according to claim 22, wherein the plant is adapted to couple the film gripper over a third distance with a second feed actuator independent of the transport belt feed actuator.

24. The plant according to claim 1.

25. A method for operating a plant for manufacturing bags from two layers of plastic film, with a film gripper for drawing the plastic film into a tool at a first station and with a circulating transport belt for transporting the film through several stations, the method including the following steps:
a. positioning the film gripper for gripping the plastic film in fact by way of a relative movement with respect to the transport belt and/or with respect to a film feed actuator;
b. gripping the plastic film;
c. drawing the plastic film into the tool at the first station by means of the film gripper, in fact coupled or synchronized with the film feed actuator; and
d. drawing the plastic film further to the second station by means of the film gripper, in fact coupled or synchronized with the transport belt.

26. The method according to claim 25, wherein the positioning of the film gripper for gripping the plastic film (step a) takes place by sliding the film gripper forward along the transport belt and in fact by means of a first feed actuator which drives back afterwards.

27. The method according to claim 25, wherein gripping (step b) takes place by needling the plastic film on a needle at the film gripper.

28. The method according to claim 25, wherein drawing of the film into the first station (step c) takes place by means of a second feed actuator which is directly connected mechanically to a film feed actuator.

29. The method according to claim 25, wherein after drawing the plastic film into the first tool, the second feed actuator disengages the plastic film and drives back.

30. The method according to claim 25, wherein after disengagement of the second feed actuator, the film, driven by the film gripper, is transported further by a transport belt feed actuator.

31. The method according to claim 30, wherein a central electrode block shoves the film gripper with its front face.

32. The method according to claim 25, wherein the film gripper grips the plastic film on the level of a product to be manufactured with two successive use parts being separated from one another without waste strips.

33. A medical bag filled with a liquid, manufactured with a plant according to claim 1.
